(19) United States
(12) Patent Application Publication
(10) Pub. No.: US 2017/0319301 A1
(43) Pub. Date: Nov. 9, 2017

(54) APPARATUS FOR PREVENTING DENTAL IMPLANT ABUTMENT FROM BEING LOOSENED

(71) Applicant: Min young LEE, Busan (KR)

(72) Inventor: Min young LEE, Busan (KR)

(21) Appl. No.: 15/531,091

(22) PCT Filed: Apr. 20, 2015
(86) PCT No.: PCT/KR2015/003908

§ 371 Date: May 26, 2017

(30) Foreign Application Priority Data
Dec. 8, 2014 (KR) 20-2014-0009024
Mar. 5, 2015 (KR) 10-2015-0031061

(51) Int. Cl. A61C 8/00

(52) U.S. Cl. CPC A61C 8/0068; A61C 8/0012; A61C 8/0022

(57) ABSTRACT

The present invention relates to an apparatus for preventing an abutment from being loosened in a dental implant comprising: a fixture (10) which is fixedly installed in a jawbone (1); the abutment (20) coupled to the fixture (10) includes an upper hole (23a) having a bottom surface (24) and a lower hole (23b); and a fastening screw (40) for fixing the abutment (20) to the fixture, wherein the apparatus suppresses unfastening of the fastening screw (40) fastened to the screw part (13) of the fixture (10), thereby preventing the abutment (20) from being loosened from the fixture (10).

### TECHNICAL FIELD

The present invention relates to an apparatus for preventing a dental implant abutment from being loosened, and more particularly, to an apparatus for suppressing unfastening of a fastening screw, through which an abutment is coupled to a fixture, to prevent the abutment from being loosened with respect to the fixture.

### BACKGROUND ART

A dental implant according to the related art is generally known and disclosed in Korean Patent Application No. 10-2009-0070982 A1 below. As illustrated in FIGS. 1 and 2, the dental implant according to the related art includes a fixture 3 inserted into and fixed to a jawbone, an abutment 5 coupled to the fixture 3, a fastening screw 7 for fixing the abutment 5 to the fixture 3, and an artificial tooth 9 coupled to an upper portion 5a of the abutment 5.

In the dental implant according to the related art, the fastening screw 7 passes through a hole 5c of the abutment 5 and then is fastened and fixed to a screw part 3c of the fixture 3, and when the fastening screw 7 is further tightened, a bottom surface of a head part of the fastening screw 7 is closely attached and fixed to a bottom surface 5d of the hole 5c of the abutment 5.

However, in the coupling structure using the fastening screw, there is no unit for preventing the fastening screw and the abutment from running idle with respect to each other. Thus, as a time elapses after the implant procedure, the fastening screw 7 may be unfastened slightly by a load repeatedly applied to a tooth to cause a problem in which the abutment 5 is loosened and shaken with respect to the fixture.

Particularly, the abutment usually mode of a titanium material has a problem in that a color changes as the time elapses after the implant procedure. In order to solve this problem of the titanium material abutment, an abutment made of a ceramic material instead of the titanium material is increasing in use. However, since the abutment made of the ceramic material has a friction coefficient less than that made of the titanium material, frictional force between the abutment and the fastening screw is small. As a result, the fastening screw is unfastened, which is a major cause of hindering the spread of the ceramic material abutment.

### DISCLOSURE OF THE INVENTION

### Technical Problem

The present invention has been invented to overcome the abovementioned problems of the dental implant according to the related art, and an object of the present invention is to provide an apparatus for preventing an abutment from being loosened with respect to a fixture by providing the ceramic material abutment, which is not discolored after a long time elapses after procedure.

### Technical Solution

To achieve the abovementioned object, the present invention includes

an apparatus for preventing an abutment from being loosened by suppressing unfastening of the fastening screw in a dental implant, including: a fixture which is fixedly installed in a jawbone and has a screw hole in an upper end surface thereof in a central axis direction; an abutment which has a lower portion coupled to the fixture and having an upper hole with a bottom surface and a lower hole, through which a threaded part of a fastening screw passes, and has an upper portion in which an artificial tooth is provided; and a fastening screw which has a threaded part successively passing through the upper hole and the lower hole of the abutment so as to be coupled the screw hole of the fixture and allow a bottom surface of a head part to come into contact with the bottom surface of the upper hole of the abutment and thereby to fix the abutment to the fixture, characterized in that

the apparatus for preventing the abutment from being loosened includes:

at least one coupling protrusion or coupling groove formed in the bottom surface of the upper hole of the abutment; and

an anti-loosening washer which is inserted into the upper hole so that the bottom surface faces the upper hole bottom surface of the abutment, has a screw hole passing therethrough in a central axis direction to allow the threaded part of the fastening screw to pass therethrough in a screw coupling manner, and is provided with at least one coupling groove or coupling protrusion having a planar top surface to come into frictional contact with the bottom surface of the head part of the fastening screw and a bottom surface shape-coupled to the coupling protrusion or the coupling groove formed on the bottom surface of the upper hole.

The abutment may be made of a ceramic material, and at least one coupling groove may be provided in the upper hole bottom surface of the abutment, and a coupling protrusion coupled to the coupling groove of the abutment may be provided in the bottom surface of the anti-loosening washer.

Alternatively, the abutment may be made of a ceramic material, and at least one coupling protrusion may be provided on the upper hole bottom surface of the abutment, and a coupling groove coupled to the coupling protrusion of the abutment may be provided in the bottom surface of the anti-loosening washer.

### Advantageous Effects

According to the present invention, since the anti-loosening washer is fixed to the abutment without being slid by coupling the coupling protrusion of the bottom surface of the anti-loosening washer to the coupling groove of the bottom surface of the upper hole, although the external impact or vibration is repeatedly applied in the state in which the abutment is coupled to the fixture, the unfastening of the fastening screw may be suppressed to prevent the abutment from being shaken, thereby firmly maintaining the dental implant after the procedure.

Also, since the unfastening of the abutment is prevented by the apparatus for preventing the abutment from being loosened, the ceramic material abutment may be applied and supplied to the implant system.

### BRIEF DESCRIPTION OF THE DRAWINGS

FIG. 1 is a coupling cross-sectional view of a state in which a dental implant is installed in a jawbone of a patient according to a related art;

FIG. 2 is an exploded perspective view of the dental implant according to the related art;

FIG. 3 is an exploded view of a dental implant including an apparatus for preventing loosening according to a first embodiment of the present invention;

FIG. 4 is a cross-sectional view of a state in which a dental implant of FIG. 3 is installed in a gum of a patient;

FIG. 5 is a view of an anti-loosening washer according to the first embodiment of the present invention, where FIG. 5(a) is a longitudinal cross-sectional view, and FIG. 5(b) is a bottom view of FIG. 5(a),

FIG. 6 is a plan view of an abutment according to the first embodiment of the present invention, and

FIG. 7 is an exploded perspective view of a dental implant including an apparatus for preventing loosening according to a second embodiment of the present invention.

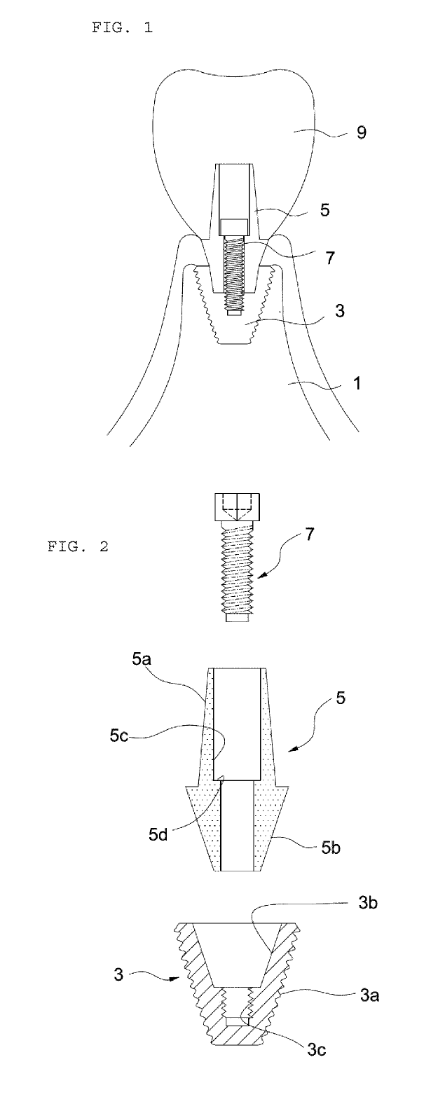

### MODE FOR CARRYING OUT THE INVENTION

Hereinafter, preferred embodiments of an apparatus for preventing a dental implant abutment from being loosened according to the present invention will be described in detail with reference to the accompanying drawings.

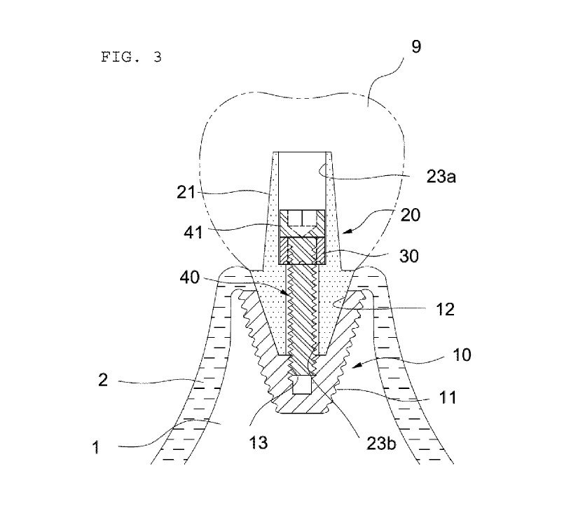

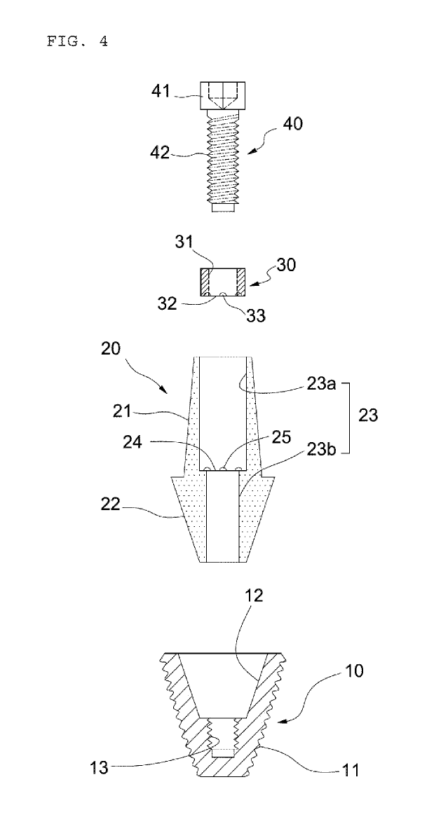

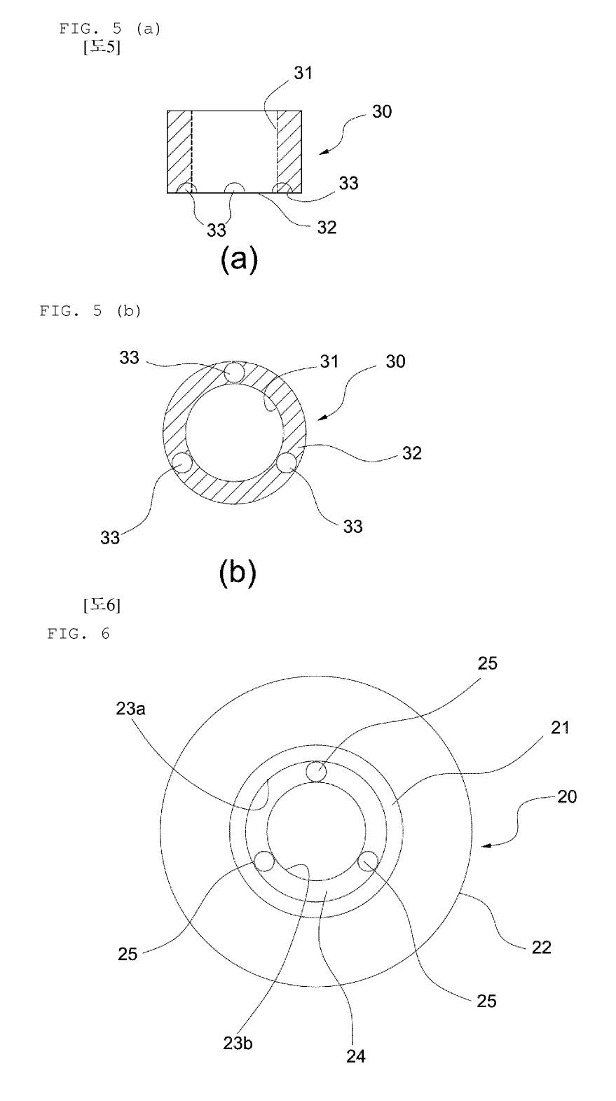

FIG. 3 is an exploded view according to a first embodiment of the present invention, FIG. 4 is a coupling cross-sectional view according to the first embodiment of the present invention, and FIG. 5 is a cross-sectional view of an anti-loosening washer according to the first embodiment.

As illustrated in FIGS. 3 and 4, a dental implant according to the first embodiment of the present invention includes a fixture 10 fixed and installed in a jawbone 1, an abutment having a lower portion coupled to a coupling part 12 of the fixture 10 and an upper portion 21 in which an artificial tooth 9 is installed, and a fastening screw 40 for coupling and fixing the abutment 20 coupled to the fixture 10. Also, the present invention further includes an apparatus for preventing the abutment 20 from being loosened by suppressing unfastening of the fastening screw 40.

A screw 11 is formed on an outer circumferential surface of the fixture 10 so that the fixture 10 is fixed to the jawbone 1. Also, the fixture includes a coupling part 12 coupled to a lower portion 22 of the abutment 20 and a screw hole 13 to which a threaded part 42 of the fastening screw 40 is coupled.

The coupling part 12 of the fixture 10 has a shape corresponding to that of the lower portion 22 of the abutment so as to be coupled to the lower portion 22 of the abutment. In case of the first embodiment of FIG. 3, the coupling part 12 of the fixture has a truncated conical hole, of which an end is cut, corresponding to the lower portion 22 of the abutment 20 having a conical shape, of which an end is cut. However, in case of a second embodiment illustrated in FIGS. 7 and 8, since the lower portion 22 of the abutment has a coupling protrusion having a hexagonal shape, a coupling part of the fixture coupled to the lower portion 22 of the abutment may have a hexagonal groove. On the other hand, although not shown, when the lower portion of the abutment has a hexagonal groove, the coupling part 12 of the fixture may include a coupling protrusion having a hexagonal shape.

The abutment 20 may be preferably made of ceramic. The abutment 20 is manufactured through a casting or injection molding method. Also, the abutment 20 may be made of a titanium material. As illustrated in FIG. 3, the abutment 20 includes the lower portion 22 coupled to the coupling part 12 of the fixture 10 in a shape coupling manner and the upper portion 21 integrally extending from the lower portion 22 so that the artificial tooth 9 is installed.

Also, as illustrated in FIGS. 3, 4, and 6, the abutment 20 has a hole 23 passing through a fastening screw 40 in a central axis direction. The hole 23 is constituted by a lower hole 23b through which the threaded part 42 of the fastening screw 40 passes and an upper hole 23a into which a head part 41 of the fastening screw 40 is inserted, like the general abutment. A bottom surface 24 coming into face-to-face contact with a bottom surface of the head part 41 of the fastening screw is disposed on a lower end of the upper hole 23a.

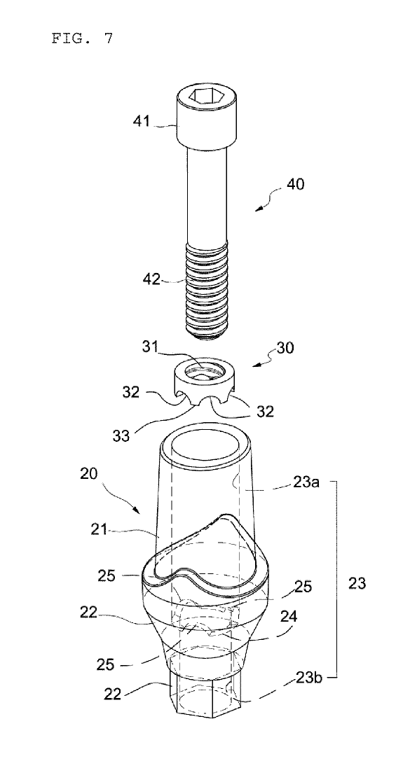

As illustrated in FIGS. 3 and 6, a plurality of coupling protrusions 25 coupled to fastening screw-side coupling grooves 32 that will be described later are disposed on the bottom surface 24.

As illustrated in FIGS. 3 and 5, the apparatus for preventing the abutment from being loosened according to the first embodiment of the present invention includes the plurality of coupling protrusions 25 disposed on the bottom surface 24 of the upper hole 23a of the abutment, a plurality of coupling grooves 32 coupled to the plurality of coupling protrusions 25, and an anti-loosening washer 30 inserted into the upper hole 23a so that the bottom having the coupling groove faces the bottom surface 24 of the upper hole 23a of the abutment 20.

In the apparatus for preventing the abutment from being loosened according to the first embodiment of the present invention, the anti-loosening washer 30 is inserted and installed in the upper hole 23a of the abutment 20 so that each of the coupling protrusions 25 of the abutment 20 is coupled to each of the coupling grooves 32 of the anti-loosening washer 30. In this state, when the fastening screw 40 passes through the screw hole 31 of the anti-loosening washer 30 in a screw coupling manner and then is coupled to the screw hole 13 of the fixture 10, the anti-loosening washer 30 is closely attached and fixed to the abutment 20 in a state in which the coupling groove 32 of the anti-loosening washer 30 and the coupling protrusion 25 of the abutment 20 are coupled to each other to suppress the unfastening of the fastening screw 40, thereby preventing the abutment 20 from being loosened.

On the other hand, a coupling protrusion may be formed on a side of the anti-loosening washer 30, and a coupling groove coupled to the coupling protrusion may be formed on the bottom surface 24 of the upper hole of the abutment 20.

FIG. 7 illustrates an artificial tooth including an apparatus for preventing an abutment from being loosened according to a second embodiment of the present invention.

The apparatus for preventing the abutment from being loosened according to the second embodiment includes an anti-loosening washer 30 having a plurality of coupling grooves 32 in a bottom surface 33 thereof in a central axis direction, having a screw hole 31 through which a threaded part 42 of a fastening screw 40 passes in a screw coupling manner, inserted into an upper hole 23a so that the bottom surface 33 faces a bottom surface 24 of the upper hole 23a of the abutment 20 and a plurality of coupling protrusions 25 coupled to the coupling grooves 32 of an anti-loosening washer 30 on the bottom surface 24 of the upper hole 23a of the abutment.

In the apparatus for preventing the abutment from being loosened according to the second embodiment, like the first embodiment, since each of the coupling grooves 32 of the anti-loosening washer 30 and each of the coupling protrusions 25 of the abutment 20 are coupled to each other, the anti-loosening washer 30 may be prevented from relatively rotating with respect to the abutment 20. In this state, the threaded part 42 of the fastening screw 40 is fastened and fixed to the screw hole 13 of the fixture 10 in a state of being screw-coupled to the screw hole 31 of the anti-loosening washer 30 to prevent the anti-loosening washer 30 from running idle. Therefore, since the anti-loosening washer 30 is fixed to the screw hole 31 of the fastening screw 40 in the screw coupling manner, and simultaneously, the coupling groove 32 of the bottom surface 33 is engaged with the coupling protrusion 25 of the abutment 20 to prevent the abutment 20 from relatively rotating, even though the abutment is made of the ceramic material having relatively low frictional resistance, the unfastening of the fastening screw 40 may be suppressed to prevent the abutment 20 from being loosened with respect to the fixture 10.

10: Fixture

11: Screw 12: Coupling part

13: Screw hole 20: Abutment

21: Upper portion 22: Lower portion

23: Fastening screw hole 23a: Upper hole

23b: Lower hole 24: Upper hole bottom surface

25: Coupling protrusion 30; Anti-loosening washer

31: Screw hole 31: Screw hole

32; Coupling groove 33: Bottom surface

40: Fastening screw 41: Head part

42: Threaded part

1. An apparatus for preventing an abutment from being loosened in a dental implant comprising: a fixture (10) which is fixedly installed in a jawbone (1) and has a screw hole (13); an abutment (20) which has a lower portion coupled to the fixture (10) and having an upper hole (23a) with a bottom surface (24) and a lower hole 23b and has an upper portion in which an artificial tooth (9) is provided; and a fastening screw (40) which has a threaded part (42) successively passing through the upper hole (23a) and the lower hole (23b) of the abutment (20) to fix the abutment (20), which is coupled to the screw hole (13) of the fixture (10), to the fixture (10),
wherein the apparatus for preventing the abutment (20) coupled to the fixture (10) from being loosened comprises: at least one coupling protrusion or coupling groove formed in the bottom surface (24) of the upper hole (23a) of the abutment (20); and an anti-loosening washer (30) which is inserted into and installed in the upper hole (23a) of the abutment (20) in a coaxial direction, has a screw hole (31) passing therethrough in a central axis direction to allow the threaded part (42) of the fastening screw (40) to pass therethrough in a screw coupling manner, and is provided with at least one coupling groove or coupling protrusion, which is coupled to be engaged with the coupling protrusion or the coupling groove of the abutment (20), on a bottom surface (33),
wherein when the threaded part (42) of the fastening screw (40) passes through the screw hole (31) in the screw coupling manner and is coupled to the screw hole (13) of the fixture (10), the coupling groove or the coupling protrusion of the bottom surface (33) is shape-coupled to the coupling protrusion (25) or the coupling groove of the upper hole bottom surface (24) of the abutment (20).

2. The apparatus of claim 1, wherein at least one coupling protrusion is provided on the bottom surface (24)of upper hole of the abutment (20), and a coupling groove coupled to the coupling protrusion of the abutment (20) is provided in the bottom surface of the anti-loosening washer (30).

3. The apparatus of claim 1, wherein at least one coupling protrusion is provided on the upper hole bottom surface (24) of the abutment (20), and a coupling groove coupled to the coupling protrusion of the abutment (20) is provided in the bottom surface of the anti-loosening washer (30).

4. The apparatus of claim 1, wherein the abutment (20) is made of ceramic.
